(19) United States
(12) Patent Application Publication
(10) Pub. No.: US 2003/0014277 A1
(43) Pub. Date: Jan. 16, 2003

(54) Multi-user process for developing entertainment projects

(76) Inventor: Timothy Patrick Kinney, Goshen, CT (US)

Correspondence Address: Timothy P. Kinney, 107 Sherbrook Drive, Goshen, CT, 06756, US

(21) Appl. No.: 10/187,093

(22) Filed: Jul. 1, 2002

Related U.S. Application Data
(60) Provisional application No. 60/302,841, filed on Jul. 3, 2001.

(51) Int. Cl. G06F 17/60

(52) U.S. Cl. 705/1

(57) ABSTRACT

A process for developing entertainment projects that captures the preferences of consumers and directly alters the creative aspects of produced entertainment projects. Consumer preferences are determined by the staging a web-based poll of registered qualified voters, sponsored by the user. The result of the web-based poll is the sole deciding factor of a specific set of at least two unique alternatives (pre-determined by the process user) which alters the course of production of the entertainment project. The production of the entertainment project is thus changed according to the preferences of the consumers, as represented by the registered qualified voters in the web-based poll. Once the entertainment project is produced using the process, it carries the process seal of approval verifying that the project was produced using the method. The process is unique in that it allows consumers the opportunity to directly influence the development of artistic content, by voting on decisions typically controlled either by the artists or by the artist's producers. So, instead of producing artistic content and then trying to sell it to fans after the fact, the process allows its user to produce artistic content according the desires of a particular market.

### CROSS-REFERENCE TO RELATED APPLICATION

This application is entitled to the benefit of Provisional Patent Application Ser. No. 60/302,841 filed Jul. 3, 2001.

### FEDERALLY SPONSORED RESEARCH

Not applicable

### SEQUENCE LISTING OR PROGRAM

Not Applicable

### BACKGROUND OF THE INVENTION—FIELD OF INVENTION

This invention relates to the production of entertainment, specifically to the method of producing entertainment projects directly altered by consumer preferences.

### BACKGROIUND OF THE INVENTION

Producers of entertainment, particularly recorded entertainment such as record labels and film studios, are faced with many challenges today as a result of recent technology developments: digitally encoded content distributed electronically via the internet. Music and movie files can easily be created, reproduced and mass distributed without the control of the traditional record label or studio.

Much debate and litigation has taken place over the past 2 years as record labels fight for control, mostly over copyright of recorded material. MP3, NAPSTER, and others have been taken to court over copyright infringement. Record labels are, for the most part, triumphant in these cases. The threat for record labels is still present, however, since most of the debate centers on copyright infringement of previously recorded artistic content. The real threat for record labels and studios comes when a new business model of production and distribution is adopted for new artistic content, leaving them out of the model. The threat of the new model gains momentum if artists seeking greater control over their business decide to abandon traditional labels in favor of the new revenue structure.

The market outlook for the dominant record labels is still incredibly strong, despite these challenges. First, there are sufficient barriers to entry, which will most likely deter start-ups from bringing artistic content to market using a new model. Another positive factor for large production companies is consolidation of the market place, which continues as professional labels acquire internet companies which may pose a threat, e.g., the AOL/TIME WARNER merger, BERTELSMANN AG acquires myplay Inc., and VIVENDI UNIVERSAL SA acquires MP3.COM. Also, most entertainment artists are not particularly savvy business managers and need the management talent and distribution channels provided by traditional labels.

To be sure, the dominant record labels and film studios still have the advantage even in the new economy. To keep that advantage, however, several questions should be addressed. How does one compete when artistic content (music, certainly, as well as the potential for film, television and theater) may be available on-line for free? How will labels, artists, and the entire supply chain make money? How does one build demand for new artistic content? Or, why will fans continue to pay for entertainment when they can get it for free? How does a record label bridge markets? How can a label leverage the selling strength of one artist to push a weaker-selling artist?

The invention covered in this application is a business method developed to answer these questions in the creation of a multi-user process for producing entertainment projects. The method helps entertainment producers build demand for new artistic content utilizing simple web-based voting technology in order to bridge a connection to on-line entertainment consumers.

The process is unique in that it allows consumers the opportunity to directly influence the development of artistic content, by voting on decisions typically controlled either by the artists or by the artist's producers. So, instead of producing artistic content and then trying to sell it to consumers after the fact, the process allows record labels to produce content according the desires of a particular market. By relinquishing certain elements of creative control, entertainment companies gain direct access to their markets, new insight into those markets, while building demand for new product.

Entertainment consumers typically are fans of particular artists, not particular labels or studios. The process gives entertainment companies a unique way to improve brand loyalty so that consumers become fans of the label or studio itself, as well as the particular artists under contract at a given time by that company.

The process provides its users with many other distinct advantages including:

Leverage of stronger selling artists under contract with weaker artists under contract.

Ability to leverage strength of one genre fan base with another genre fan base.

Sales forecasting accuracy and market data collection and reporting.

Increased opportunities for promotion of new content, even prior to its actual production.

Greater control over on-line distribution and sales.

Sell previously recorded artistic content as a tie-in to election promotion.

Increased brand loyalty.

There currently is no direct competition to the process. No record label or studio conducts elections, the outcomes of which directly impact the creative aspects of the production of new content. All fan polls today, on-line or otherwise, are usually conducted after the fact and regarding the consumer opinion of a given artist, film, or musical piece.

One web-based company, garageband.com, does poll its members for its favorite new independent band. The winner of the vote is then eligible for a professional record contract with a major record label. These elections, however, do not influence the creative decisions for that band's artistic content. VIACOM'S VH1 sponsored the 2001 MY Music Awards whereby on-line voters determined the categories and winners of the award show. An award show, may be considered entertaining, is not typically regarded as artistic content or artwork.

Another label representing the artist Björk, allows fans to vote on the song list for the artist's next greatest hits album. The fans' vote, however, does not influence the performer's artistic content of entertainment projects currently in development, only a collection of previously recorded songs.

The candy manufacturer, MARS, INCORPORATED, the maker of the famous M&M's candy, has recently conducted a web-based poll, whereby voters submit their choice for the next color of an M&M. In this instance, voters are not qualified, nor is there a guarantee that the candy maker will actually produce the candy color according the outcome of the poll.

There are also fantasy sports programs and leagues in the market where fans create fictional teams comprised of real sports figures. These fictional teams created by fans are never assembled or compete in reality.

### BACKGROUND OF THE INVENTION—OBJECTS AND ADVANTAGES

The invention is a consumer influenced (multi-user) method of developing entertainment projects. The invention focuses on four (4) critical areas of entertainment project development, including strategy, market research, project and product development, and marketing. Applied strategically, the invention gives its user new insight into its customer base, helps build brand loyalty, reduces waste, and provides an innovative platform to sell new projects and products.

The invention is revolutionary in scope, yet actually simple in execution. The invention allows consumers, in addition to producers of entertainment, the opportunity to influence the direction of new entertainment project development using a simple web-based qualification and voting procedure. The preferences of the qualified voting consumers actually guide the design and production of the new entertainment project. When distributed or produced theatrically, these new consumer-influenced projects and products carry the invention's seal of approval. This seal notifies consumers that the new project or product meets the preference requirements set by qualified registered voting consumers.

The invented method is comprised of the following six (6) steps in the order that they appear:

(1.) Staging.

Entertainment projects and products are selected by the user to enter the process. Parameters for consumer influence are selected for the upcoming web-based poll. The user's last generation projects and products are distributed carrying unique registration codes and invitations to consumers to participate in the upcoming web-based poll.

This first step is critical. Several strategic decisions as well as tactical planning and preparation takes place at this time in order to ensure that the election supports the objectives of the user. The user must decide which project and product will be entered into the process, which elements of the project or product will be up for election, when the election will be held, and which specific demographic data should be collected during the election.

The user also needs to prepare its marketplace for the upcoming election, including the development of promotional material. The election website needs to be constructed. Registration codes need to be created and distributed to the market. Other preparations may need to be made unique to the specific needs of the user.

(2.) Consumer Qualification.

Consumers of the user's entertainment projects and products are invited to log on to the user's website to become participating voters. Entrance to the site is allowed only with the unique registration codes distributed at the point of sale of the user's last generation projects and products in accordance with Step (1.). Registration codes may only be entered once, ensuring that there is only one vote per registration codes. Consumers of multiple projects and products may submit more than one vote per election as long as that consumer holds more than one registration code.

Consumer participation in the election process is not random, nor is it open to the general public. In order to participate, consumers must first be qualified. To become qualified, participants must first obtain a unique registration code distributed by the invention user. Registration codes are distributed with the user's last generation of entertainment projects and products.

To ensure that only consumers of the user's products participate in the process, upon purchase of the project or product, customers are given an invitation and instruction to participate in the upcoming election, and a unique registration code.

Customers may then log onto the user web site. This registration code verifies that the product was actually purchased as well as other desirable data determined by the user (e.g., retail location, method of payment, etc.). Once a registration code is submitted, it will never be accepted into the database again. That is, one registration code grants one vote. There are several non-proprietary programming options available (e.g., ASP techniques or JAVA scripting) to accomplish this function, depending on the user's technology environment. The invention is not dependent upon one specific programming technique.

Submitting the registration code gives qualified consumers access to the election staging and launches the registration section page of the site.

(3.) Voter Registration and Demographic Data Collection.

Once qualified consumers make access to the user website, qualified consumers now may register to vote. Voting registration consists of the qualified consumer providing personal data, purchasing preferences, and any other market surveys determined by the user. Collected demographic data for each qualified user is stored in the user's database and can be used later to develop marketing campaigns, direct mail, and help target potential customers via advertising. Examples of the types of demographic data are: names, addresses, phone numbers, fax numbers, e-mail addresses, ages, sex, income, buying preferences, survey responses, entertainment preferences, etc.

Some users may opt to include a statement of necessary terms and conditions with a digital consent form to which qualified consumers must accept before allowing full registration and access to the election site.

(4.) Web-based Election.

Registered qualified voters logged into the user website may now submit their preferences via electronic ballot based on the pre-determined parameters of the election selected by the user in Step (1.). Results of the election are captured electronically and tallied. A 51% majority of the population of registered qualified voters is used to determine the winning preference of any staged election.

The web-based election is the point in the process where registered qualified voters actually interface with the user via the web, to exert their preference influence over the development of the entertainment project or product. The user may allow registered qualified voters to elect as many or as few (but no less than two) choices that will alter the production of the project or product.

(5.) Election-Influenced Production.

The user's entertainment projects and products as selected in Step (1.) are then produced in accordance with the results of the election held in Step (4.).

What makes the invention exceptionally unique takes place here in Step (5.). The results of the election actually alter the course of the production of the entertainment project or product. Preferences, as identified by the submitted votes from registered qualified consumers, will be the deciding factor of the user's entertainment production. Once the election closes, the user will then produce entertainment according the results of the election.

(6.) Seal of Approval.

Once the user's entertainment projects and products are produced in accordance with Steps (1-5) detailed above, the user distributes the entertainment projects and products carrying a seal of approval verifying that the entertainment project and product was in fact produced in accordance with the process specification method.

The seal of approval may be printed, affixed with a sticker label, or some other product-packaging device upon distribution of the project or product. The seal of approval shall be used as part of the promotional initiatives for the entertainment project or product including (but not limited to), point of sale displays, advertising, tradeshows, public relations, sales literature, and websites.

### SUMMARY

In accordance with the invention process, the preferences of the consumers, as represented by registered qualified voters, are used by the invention user to create entertainment projects and products in strict accordance with the majority vote of registered qualified consumers.

### DRAWINGS—FIGURES

In the figures, flowcharts have been created to aid the reader with specific steps detailed in this invention specification.

FIG. 1 shows how a registration code is entered, accepted or rejected from a user website in Step (2.) of the process.

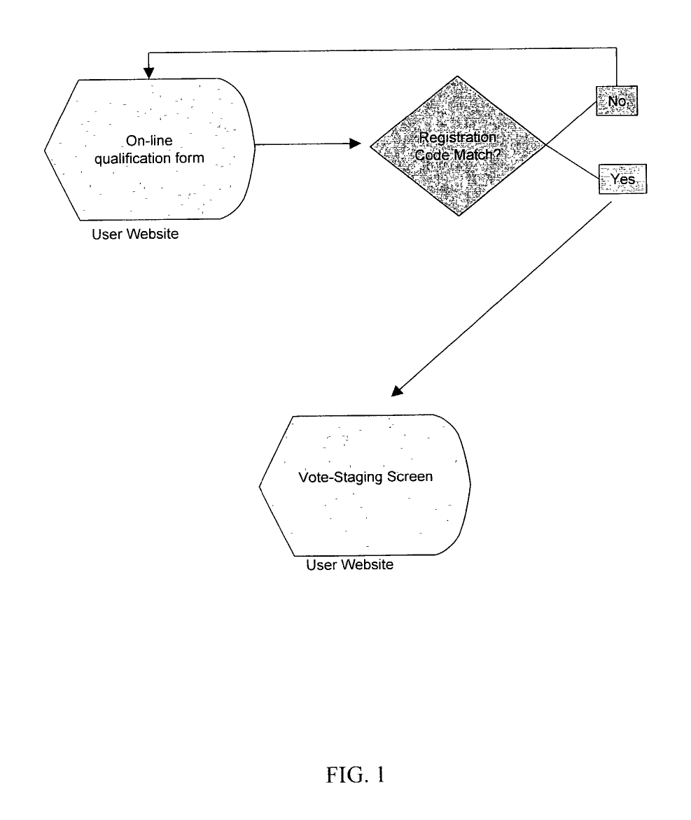

FIG. 2 shows how customer demographic data is captured and stored and launches to the registration page of the user website in Step (3.) of the process.

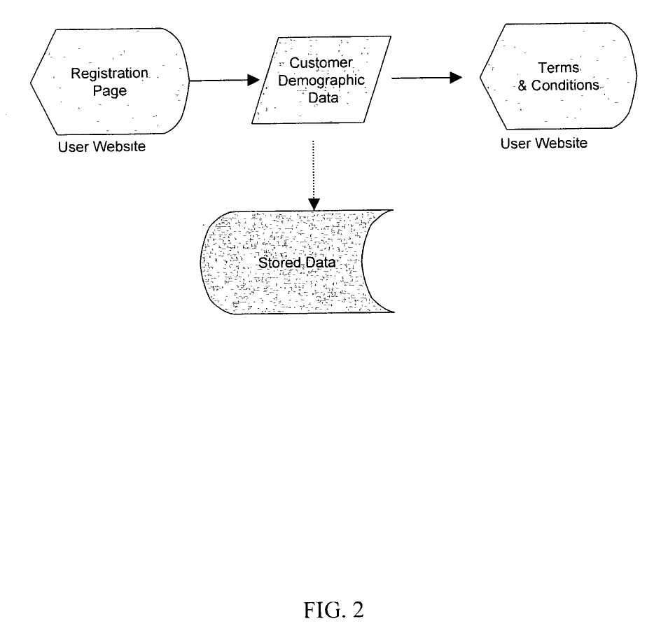

FIG. 3 shows an example of the type of data captured in the registration page in Step (3.) of the process.

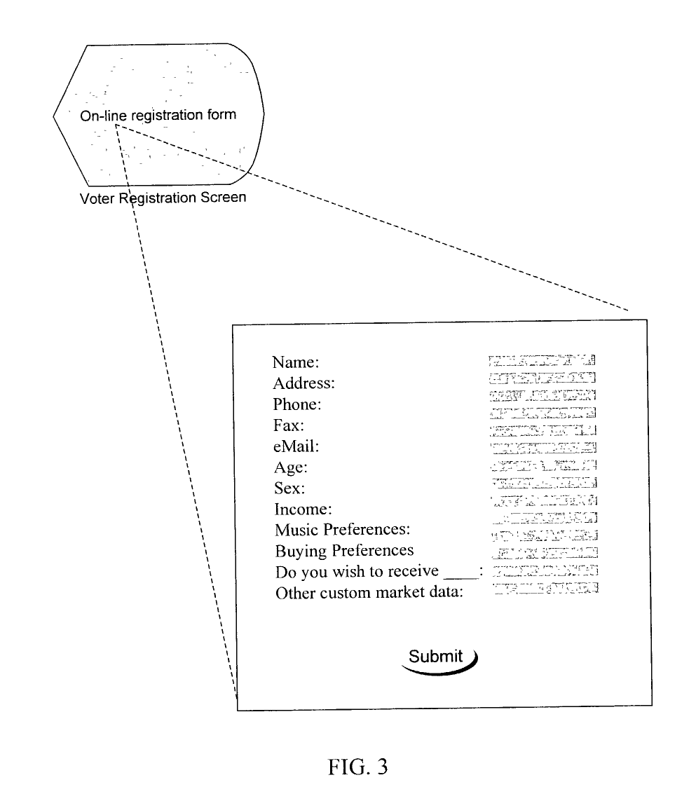

FIG. 4 shows the flow of data from the registration page to the stored database to the launch of the election-staging page of the user website in Step (3.) of the process.

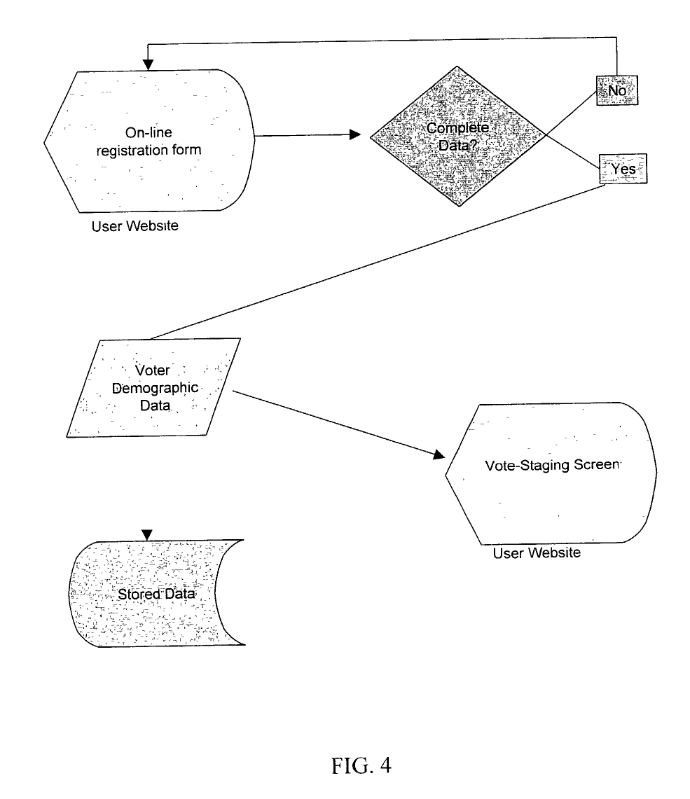

FIG. 5 shows the acceptance or rejection feature of the optional user rules and regulations page of the user website in Step (3.) of the process.

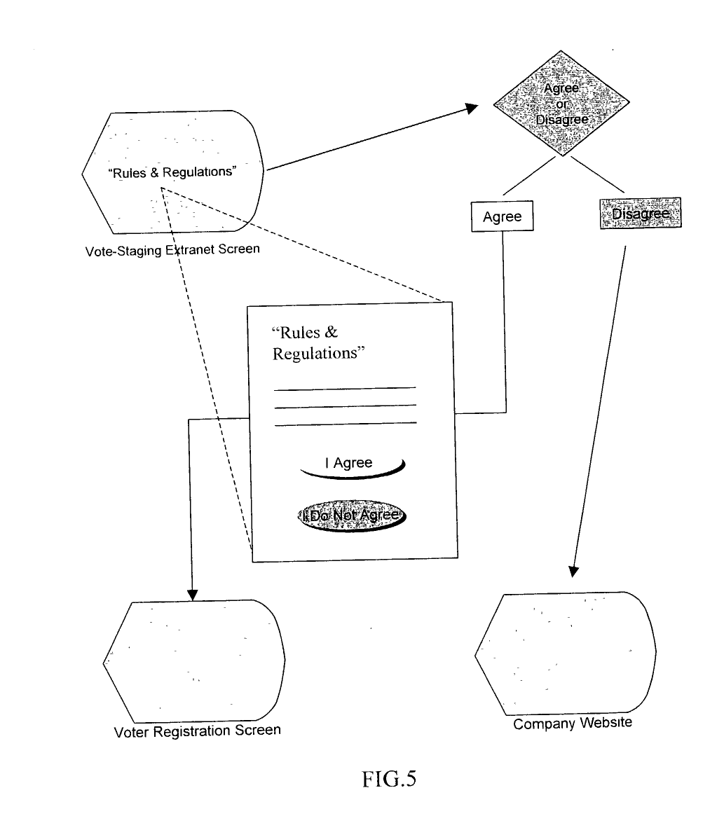

FIG. 6 shows the launch feature of the user website in the event of multiple election stagings.

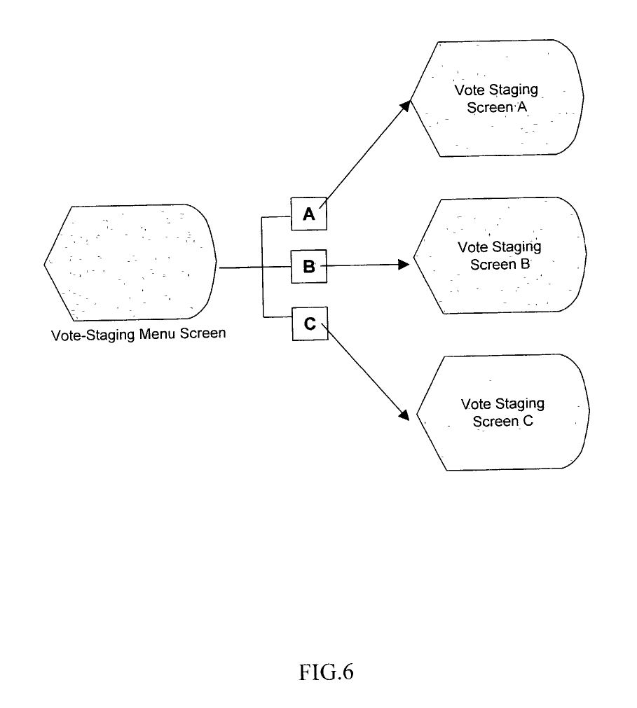

FIG. 7 shows the flow of data capturing the registered qualified voter's preference on the user website in Step (4.) of the process.

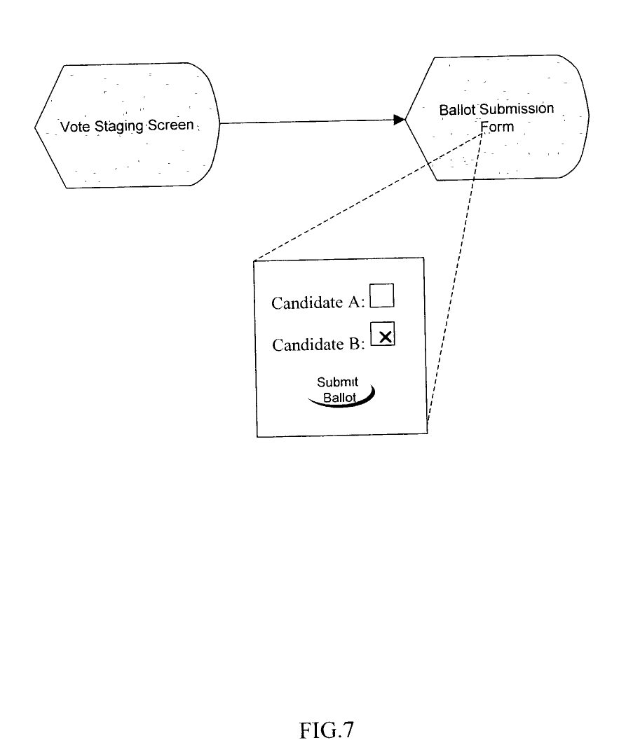

FIG. 8 shows the flow of election preference data as it is submitted from the registered qualified voter on the user website, stored and tallied in Step (4.) of the process.

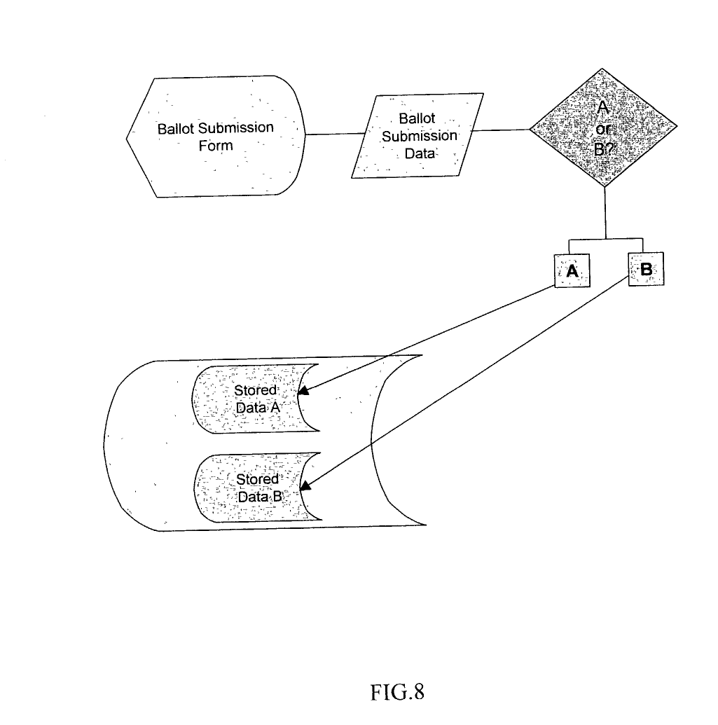

### CONCLUSIONS, RAMIFICATIONS, and SCOPE

Accordingly, the reader will see that the process can be effectively used to create entertainment projects that directly capture the preferences of consumers and subsequently influences the creative aspects of produced entertainment projects.

Applied strategically, the process has a positive impact on its user's business strategies, market research, production development, and marketing efforts. The process provides its users with many other distinct advantages including:

Leverage of stronger selling artists under contract with weaker artists under contract.

Ability to leverage strength of one genre fan base with another genre fan base.

Sales forecasting accuracy and market data collection and reporting.

Increased opportunities for promotion of new content, even prior to its actual production.

Greater control over on-line distribution and sales.

Sell previously recorded artistic content as a tie-in to election promotion.

Increased brand loyalty.

Thus, the scope of the invention should be determined by the appended claims and their legal equivalents, rather than by the examples given.

I claim:

1. A method of producing artistic content for an entertainment, comprising the steps of:
conducting a web-based poll of a voter population to determine a voter preference among various entertainment alternatives;
producing an entertainment in accordance with the voter preference determined in the said web-based poll;
said produced entertainment carries a seal of approval verifying that said produced entertainment was produced in accordance with said method.

2. A method in accordance with claim 1, wherein said entertainment comprises recorded music.

3. A method in accordance with claim 1, wherein said entertainment comprises recorded music and video.

4. A method in accordance with claim 1, wherein said entertainment comprises filmed entertainment.

5. A method in accordance with claim 1, wherein said entertainment comprises live music.

6. A method in accordance with claim 1, wherein said entertainment comprises live theater.

7. A method in accordance with claim 1, wherein said entertainment comprises live television.

8. A method in accordance with claims 1-7, wherein said entertainment alternatives comprise different performers selected to have performing roles in said entertainment.

9. A method in accordance with claims 1-7, wherein said entertainment alternatives comprise different groups of performers selected to have performing roles in said entertainment.

10. A method in accordance with claims 1-7, wherein said entertainment alternatives comprise different groups of performers selected to have performing roles in said entertainment, and wherein each member of said group of performers is under contract to the same production company.

11. A method in accordance with claims 1-7, wherein said entertainment alternatives comprise different songs selected to be included in said entertainment.

12. A method in accordance with claims 1-7, wherein said entertainment alternatives comprise different artwork selected to be included in said entertainment.

13. A method in accordance with claims 1-7, wherein said entertainment alternatives comprise different story components selected to be included in said entertainment.

14. A method in accordance with claims 1-13, further comprising the steps of: qualifying the voters of said voter population when said web-based poll is conducted to create a database of qualified voters; and using said database of qualified voters to send information promoting said entertainment to said qualified voters.

15. A method in accordance with claim 14, further comprising the steps of: registering the said qualified voters when said web-based poll is conducted to create a database of registered qualified voters; and using said database of registered qualified voters to send information promoting said entertainment to said registered qualified voters.

16. A method in accordance with claim 15, wherein said step of promoting said entertainment to said database of registered qualified voters comprises sending an invitation to obtain a copy of said entertainment to one or more of said registered qualified voters.

17. A method in accordance with claim 15, wherein said step of promoting said entertainment to said database of registered qualified voters comprises sending an invitation to acquire admission to said entertainment to one or more of said registered qualified voters.

18. A method in accordance with claims 15-16, wherein said invitation to obtain a copy of or admission to said entertainment comprises advertising.

19. A method in accordance with claims 15-16, wherein said invitation to obtain a copy of or admission to said entertainment comprises an e-mail sales solicitation.
